(19) United States
(12) Patent Application Publication
(10) Pub. No.: US 2025/0141006 A1
(43) Pub. Date: May 1, 2025

(54) BATTERY STACK

(71) Applicant: Dyson Technology Limited, Wiltshire (GB)

(72) Inventors: Neil Ross SIM, Swindon (GB); Michael Edward RENDALL, Newbury (GB); Samuel John ALEXANDER, Gloucester (GB)

(21) Appl. No.: 18/694,186

(22) PCT Filed: Sep. 26, 2022
(86) PCT No.: PCT/GB2022/052430

§ 371 Date: Mar. 21, 2024

(30) Foreign Application Priority Data
Sep. 30, 2021 (GB) 2114039.7

(51) Int. Cl. H01M 50/242; H01M 10/0585; H01M 50/105; H01M 50/46; H01M 50/533

(52) U.S. Cl. CPC H01M 50/242; H01M 10/0585; H01M 50/105; H01M 50/46; H01M 50/533

(57) ABSTRACT

Battery stacks are disclosed. In examples, the battery stack comprises a plurality of electrochemical cells. Each electrochemical cell of the plurality comprises a cathode layer, an electrolyte layer arranged on the cathode layer, and an anode layer arranged on the electrolyte layer. The battery stack comprises a cathode current collector comprising at least a first portion and a second portion, the first portion arranged on the cathode layer of a first electrochemical cell of the plurality of electrochemical cells, the second portion arranged on the cathode layer of a second electrochemical cell of the plurality of electrochemical cells. Between the first portion and second portion of the cathode current collector, the cathode current collector comprises an intermediate portion, at least one surface of which coated with an electrically-insulating coating. Also described are methods of manufacturing battery stacks, functionalised current collectors and methods of manufacturing thereof, and electrically-powered devices.

### TECHNICAL FIELD

The present invention relates to battery stacks comprising a plurality of electrochemical cells, methods of manufacturing battery stacks, functionalised current collectors, methods of manufacturing functionalised current collectors, and electrically-powered devices comprising battery stacks.

### BACKGROUND

Electrochemical cells, particularly secondary solid-state electrochemical cells, expand and contract across cycles of charging and discharging (e.g. the cells undergo volumetric variation). The variation in cell thickness is particularly noticeable where one or more components of the solid-state electrochemical cell is a sintered component.

The expansion and contraction of electrochemical cells during use leads to undesirable effects when provided in a plurality of electrochemical cells which are electrically connected in a battery stack. For example, the variation in cell thickness increases the likelihood of shorting across cells in the battery stack, damaging the connectors between the cells, or detachment of the cells from their respective current collectors.

### SUMMARY

In examples of a first aspect of the present disclosure there is provided a battery stack comprising a plurality of electrochemical cells. Each electrochemical cell of the plurality of electrochemical cells comprises a cathode layer, an electrolyte layer arranged on the cathode layer, and an anode layer arranged on the electrolyte layer. The battery stack comprises a cathode current collector comprising at least a first portion and a second portion, the first portion arranged on the cathode layer of a first electrochemical cell of the plurality of electrochemical cells, and the second portion arranged on the cathode layer of a second electrochemical cell of the plurality of electrochemical cells. Between the first portion and second portion of the cathode current collector, the cathode current collector comprises an intermediate portion, at least one surface of the intermediate portion coated with an electrically-insulating coating.

Advantageously, the inventors have identified that a battery stack according to the first aspect is less prone to shorting, connector damage, or current collector detachment despite volumetric change of the cells across cycles of use.

Typically, the at least one surface of the intermediate portion coated with the electrically-insulating coating faces the cells of the battery stack. Because the coating is an electrically-insulating coating, any contact between the intermediate portion of current collector and the electrodes of the cells is less likely to short the battery stack.

In examples, the battery stack comprises an anode current collector. The anode current collector comprises at least a first portion and a second portion, the first portion arranged on the anode layer of the first electrochemical cell, the second portion arranged on the anode layer of a third electrochemical cell of the plurality of electrochemical cells. Between the first portion and second portion of the anode current collector, the anode current collector comprises an intermediate portion, at least one surface of the intermediate portion coated with an electrically-insulating coating.

In examples, the first surface of the first portion of the anode current collector abuts the anode layer of the first electrochemical cell, and a second surface of the first portion of the anode current collector, opposed to the first surface, abuts the anode layer of the second electrochemical cell.

In examples, a first surface of the second portion of the cathode current collector abuts the cathode layer of the second electrochemical cell, and a second surface of the second portion of the cathode current collector, opposed to the first surface, abuts the cathode layer of the third electrochemical cell.

The plurality of cells comprises any suitable number of cells, for example 2, 3, 4, 5, 6, 7, or 8 cells. The cells are arranged “back-to-back”, such that a cathode of a first cell is arranged opposed to a cathode of a second cell across a shared portion of current collector, and so on.

In examples, each electrochemical cell of the plurality of cells has a thickness which, in use, varies between an expanded thickness and a contracted thickness. The expanded thickness greater than the contracted thickness. When the thickness of each electrochemical cell is the expanded thickness, the electrically-insulating coating of the intermediate portion of the cathode current collector abuts a side of at least one of the electrochemical cells. Additionally, or alternatively, when the thickness of each electrochemical cell is the contracted thickness, the electrically-insulating coating of the intermediate portion of the cathode current collector is spaced apart from a side of at least one of the electrochemical cells.

The electrodes of the cells are provided as layers. A layer extends in a first dimension (thickness), second dimension (length), and third dimension (width). Typically, the thickness of a layer is its smallest dimension and the length of the layer is its greatest dimension, although this is not necessarily the case. In examples of the first aspect, the first dimension of the layers (e.g. the thicknesses) extend in the direction that the cells are stacked in the battery stack.

In examples, each of the layers of the cell has substantially the same length and/or substantially the same width. In examples, the thicknesses of the layers differ. For example, the cathode layer has a greater thickness than the electrolyte layer and the anode layer. A thicker cathode layer typically provides for a cell having greater energy density. In examples, the anode layer has a greater thickness than the electrolyte layer.

Each cell comprises a plurality of layers. Therefore, in examples, each cell has a length and width corresponding to the length and width of each layer in the cell, and each cell has a thickness corresponding to the aggregate thickness of the layers in the cell. In examples, each of the cells in the plurality of cells has substantially the same thickness (subject to volumetric variation due to cycling of the cells).

The cells undergo volumetric change across cycling of the cells. The volumetric variation from cycling of the cells results in variation in at least the thickness of one or more layers of the cells. In examples, the volumetric variation also results in variation in the length and/or width of one or more layers of the cells.

In examples, the cathode and/or anode layers of the cells exhibit volumetric variation in use (e.g. they expand and contract across charging and discharging cycles). In examples, the electrolyte layers of the cells do not exhibit volumetric variation through use.

When the one or more layers of the cells are at their greatest volumetric extent, the thickness of the cell is the expanded thickness. When the one or more layers of the cells are at their least volumetric extent, or a volumetric extent less than the greatest volumetric extent, the thickness of the cell is the contracted thickness.

When the cells of the battery stack are not at their greatest volumetric extent (e.g. not at their expanded thickness), there is slack in the intermediate portion of cathode current collector, meaning that the surface of the intermediate portion facing the cells of the battery stack is spaced apart from the cells of the battery stack (e.g. there is a lumen between the cells and the intermediate portion of current collector facing the cells). The slack in the intermediate portion allows for the expansion of the cells, such that when the cells of the battery stack are at their greatest volumetric extent (e.g. in their expanded thickness) the electrodes of the cells do not substantially detach from the current collector. The expansion of the cells typically brings the coated surface of the current collector closer to or into contact with the cells. Because the coating is an electrically-insulating coating, less shorting of the battery stack is observed through the current collector contacting a range of electrodes across the cells.

In examples, the plurality of electrochemical cells is a plurality of secondary electrochemical cells. In examples, the plurality of electrochemical cells is a plurality of solid-state electrochemical cells.

In examples, the battery stack is provided in a pouch cell.

The cathode layer of each cell comprises, consists essentially of, or consists of cathode material. In examples, the cathode material comprises, consists essentially of, or consists of: lithium cobalt oxide (LiCoO₂), typically referred to as LCO; lithium manganese oxide (LiMn₂O₄), typically referred to as LMO; lithium titanate (Li₄Ti₅O₁₂—typically referred to as LTO); lithium nickel manganese cobalt oxide (LiNi_{1-x-y}MnₓCo_{y}O₂), typically referred to as NMC; lithium iron phosphate (LiFePO₄), typically referred to as LFP, lithium nickel cobalt aluminium oxide (LiNi_{1-x-y}CoₓAl_{y}O₂), typically referred to as NCA, lithium sulfide (Li₂S); silver vanadium oxide (AgV₂O_{5.5}), typically referred to as SVO; or combinations thereof. In examples, the cathode layer is a sintered cathode layer (e.g. cathode material has undergone sintering to provide the cathode layer). In examples, the cathode layer of each cell in the plurality of cells has substantially the same composition.

The anode layer of each cell comprises, consists essentially of, or consists of cathode material. In examples, the anode material comprises, consists essentially of, or consists of: silicon, carbon, indium tin oxide (ITO), molybdenum dioxide (MoO₂), lithium titanate (Li₄Ti₅O₁₂-typically referred to as LTO), lithium alloy, metallic lithium, or combinations thereof. Where the anode comprises carbon, the anode comprises any suitable carbon-based material. For example, the anode comprises graphite, graphene, hard carbon, activated carbon, and/or carbon black. In examples, the anode layer is a sintered anode layer (e.g. anode material has undergone sintering to provide the anode layer). In examples, the anode layer of each cell in the plurality of cells has substantially the same composition.

The electrolyte layer typically comprises ceramic material. In examples, the electrolyte layer is a crystalline lithium-ion (‘Li-ion’) ceramic. The electrolyte layer typically functions as a separator between the cathode and the anode of each cell, preventing the anode and cathode from coming into direct contact and thereby short-circuiting the cell.

In examples, the electrolyte layer electrolyte material. The electrolyte material comprises, consists essentially of, or consists of: perovskite-type Li-ion conductor; anti-perovskite-type Li-ion conductor; garnet-type Li-ion conductor; sodium super ionic Li-ion conductor (NASICON); NASICON-related Li-ion conductor; lithium super ionic conductor (LISICON); LISICON-related Li-ion conductor; thio-LISICON; thio-LISICON-related Li-ion conductor; lithium phosphorous oxy-nitride (LiPON); related amorphous glassy type Li-ion conductors, or combinations thereof. In particular examples, the electrolyte material comprises lithium phosphorous oxy-nitride (LiPON), the LiPON having the following formula: LixPOyNz where x=2y+3z-5, and x<4. In examples, the electrolyte layer comprises at least 50 wt %, 80 wt %, 90 wt %, 95 wt % or 99 wt % LiPON by dry weight of the layer. In some examples, the electrolyte consists essentially of, or consists of, LiPON.

In examples, each current collector (the anode current collector and cathode current collector) is a metal foil (e.g. copper, tungsten, platinum, nickel, stainless steel), metal screen, metal film on a polymer film or sufficiently conductive SiO₂ layer, or any other known substrate or barrier layer. In examples, the current collector is a sheet comprising folds (or bends).

The electrically-insulating coating is any suitable material, e.g. electrically-insulating resin or paint. Although this element is referred to as a “coating”, it is provided to the surface of the intermediate portion of the current collector according to any suitable method—the method is additive and/or subtractive—and “coating” merely indicates that the electrically-insulating material covers, or is arranged on, at least a portion of a surface of the intermediate portion of the current collector.

In examples of a second aspect of the present disclosure there is provided a method of manufacturing a battery stack comprising a plurality of electrochemical cells. The method comprises providing a cathode current collector and providing a first cathode arranged on a surface of a first portion of the cathode current collector. The method further comprises providing a first electrolyte arranged on the first cathode, providing a first anode arranged on the first electrolyte, and providing an anode current collector such that the first anode is arranged on a first surface of a first portion of the anode current collector. The method further comprises providing a second anode arranged on a second surface of the first portion of the anode current collector, the second surface opposed to the first surface, and providing a second electrolyte arranged on the second anode. The method further comprises providing a second cathode arranged on a first surface of a second portion of the cathode current collector, and folding the cathode current collector such that the second cathode is arranged on the second electrolyte. Between the first portion and second portion of the cathode current collector, the cathode current collector comprises an intermediate portion, at least one surface of the intermediate portion coated with an electrically-insulating coating.

As used herein, “folding” comprises bending a flat, planar portion of a material such that the portion is no longer flat. For example, the portions of material adjacent to the folded (or bent) portion are not co-planar. The direction of the fold can be defined with reference to the surfaces of the material. For example, folding along a first surface of a material comprises bringing the portions of material adjacent to the folded (or bent) portion closer together.

The intermediate portions of the cathode and anode current collectors (and, when present, the electrically-insulating coating thereon) have a suitable flexibility and/or ductility to enable folding during the manufacturing of the battery stack, and to avoid failure of the current collector through repeated volumetric variation of the cells.

In examples, the method further comprises providing a third cathode arranged on a second surface of the second portion of the cathode current collector, the second surface opposed to the first surface, providing a third electrolyte arranged on the third cathode, providing a third anode arranged on the third electrolyte; and folding the anode current collector such that the third anode is arranged on a first surface of a second portion of the anode current collector. Between the first portion and second portion of the anode current collector, the anode current collector comprises an intermediate portion, at least one surface of the intermediate portion coated with an electrically-insulating coating.

In examples, the anode current collector extends along a length, and the folding the anode current collector comprises folding the anode current collector substantially perpendicular to its length. In examples, the length of the anode current collector is the greatest extent of the anode current collector (e.g. the length is greater than the thickness and width of the anode current collector).

In examples, the cathode current collector extends along a length, and the folding the cathode current collector comprises folding the cathode current collector substantially perpendicular to its length. In examples, the length of the cathode current collector is the greatest extent of the cathode current collector (e.g. the length is greater than the thickness and width of the cathode current collector).

In examples, the providing the first anode layer and the first electrolyte layer is performed simultaneously. In examples, the providing the anode current collector such that the first anode is arranged on a first surface of a first portion of the anode current collector, and the providing the second anode arranged on the second surface of the first portion of the anode current collector, are performed simultaneously. For example, the first anode layer and first electrolyte layer are provided as part of a functionalised anode current collector.

In examples, the providing a first electrolyte arranged on the first cathode, providing a first anode arranged on the first electrolyte, providing an anode current collector such that the first anode is arranged on a first surface of a first portion of the anode current collector, providing a second anode arranged on a second surface of the first portion of the anode current collector, the second surface opposed to the first surface, and providing a second electrolyte arranged on the second anode are performed simultaneously, for example, by providing a functionalised anode current collector on the first cathode (described further hereinbelow).

In examples, the providing the third electrolyte arranged on the third cathode, providing the third anode arranged on the third electrolyte, and folding the anode current collector such that the third anode is arranged on a first surface of a second portion of the anode current collector are performed simultaneously, for example, by folding the functionalised anode current collector along an intermediate portion of the functionalised anode.

In examples of a third aspect of the present disclosure there is provided a functionalised current collector comprising a current collector layer, and a plurality of electrodes, each of the electrodes abutting respective portions of a first surface of the current collector layer. Each of the electrodes is spaced apart from the other electrodes of the plurality of electrodes.

According to the present disclosure, a functionalised current collector is a current collector on which material which performs a function in a battery stack is arranged.

In examples, the functionalised current collector comprises a further plurality of electrodes, each of the electrodes abutting respective portions of a second surface of the current collector layer, the second surface opposed to the first surface. Typically, the thickness of the current collector layer extends from the second surface to the first surface.

In examples, each of the electrodes of the plurality of electrodes on the first surface of the current collector is arranged opposed to a corresponding electrodes of the further plurality of electrodes on the second surface of the current collector. For example, a first electrode arranged on the first surface of the current collector is arranged opposed to a second electrode arranged on the second surface of the current collector.

In examples, each of the electrodes of the plurality of electrodes on the first surface of the current collector has substantially the same length, thickness, and width as the corresponding electrodes on the second surface of the current collector.

In examples, the functionalised current collector comprises an electrically-insulating coating between some or each of the electrodes of the plurality of electrodes on the first surface. In examples, the functionalised current collector further comprises an electrically-insulating coating between some or each of the electrodes of the plurality of electrodes on the second surface.

In examples, the plurality of electrodes is a plurality of anodes or is a plurality of cathodes. In examples, each of the electrodes of the plurality of electrodes comprises an electrolyte layer on a surface of the electrode opposed to the current collector layer.

The functionalised current collectors are used in methods of manufacturing battery stacks as described hereinabove.

In examples of a further aspect of the present disclosure there is provided a method of manufacturing a functionalised current collector. The method comprises providing a current collector layer, and providing a plurality of electrodes on a first surface of the current collector layer, each of the electrodes spaced apart from the other electrodes of the plurality of electrodes.

The providing the plurality of electrodes comprises any suitable method, such as screen printing, deposition, and so on.

In examples, the depositing comprises physical vapour depositing. Physical vapour deposition (PVD) is an example of vacuum deposition and refers to a process wherein a condensed material is vaporised, and then at least some of the vaporised material condenses on a substrate to provide a condensed layer. Examples of PVD include thermal deposition (also referred to as evaporative deposition), and sputtering.

In examples, the depositing comprises chemical vapour depositing. Chemical vapour deposition (CVD) is an example of vacuum deposition and refers to a process wherein a substrate is exposed to one or more volatile precursors, which react and/or decompose on the substrate surface to produce a layer. Examples of CVD include low pressure chemical vapour deposition (LPCVD) and plasma enhanced chemical vapour deposition (PECVD).

In examples, the depositing comprises electrophoretic depositing. Electrophoretic deposition refers to a process wherein colloidal particles suspended in a liquid medium migrate under the influence of an electric field (electrophoresis) and are deposited onto a substrate. Examples of electrophoretic deposition include electrocoating, electrodeposition, and electrophoretic coating, and electrophoretic painting.

In examples, the depositing comprises casting. Examples of casting include spray casting, sheet casting, and spin casting. In examples, the depositing comprises screen printing.

In examples, portions of electrode material are deposited to provide discrete portions of electrode material on the first surface of the current collector (e.g. the first surface of the current collector is masked to expose only the portions of first surface to which electrode material is supplied). In other examples, electrode material is deposited to a provide a continuous portion of electrode material on the first surface of the current collector, and portions of the electrode material are removed to provide discrete portions of electrode material on the current collector. Portions of electrode material are removed according to any suitable method, such as ablation.

In examples, the providing the plurality of electrode comprises providing electrode material on the first surface of the current collector, and sintering the electrode material to provide sintered electrodes.

In examples, the second surface of the current collector is functionalised with electrodes in the same manner as the first surface, mutatis mutandis.

In examples, electrically-insulating coating is provided to one or more intermediate portions of the first and/or second surface of the current collector between the electrodes arranged on the first and/or second surface. The electrically-insulating coating is provided according to any suitable method, such as any of the deposition processes described hereinabove. The coating is not necessarily provided through a coating process. For example, the one or more intermediate portions are provided with an electrically-insulating coating through an additive process (e.g. depositing electrically-insulating material substantially only on the first and/or second surface of the one or more intermediate portions) and/or through a subtractive process (e.g. depositing electrically-insulating material on the current collector and optionally the electrodes, and removing portions of the electrically-insulating material through, for example, ablation).

In examples of a yet further aspect of the present disclosure there is provided an electrically-powered device comprising the battery stack described herein. An electrically-powered device is any apparatus which draws electric power from a circuit which includes the cell or battery stack, converting the electric power from the cell or battery stack to other forms of energy such as mechanical work, heat, light, and so on. In examples, the electrically-powered device is a smartphone, a cell phone, a personal digital assistant, a radio player, a music player, a video camera, a tablet computer, a laptop computer, military communications, military lighting, military imaging, a satellite, an aeroplane, a micro air vehicle, a hybrid electric vehicle, a plug-in hybrid electric vehicle, a fully electric vehicle, an electric scooter, an underwater vehicle, a boat, a ship, an electric garden tractor, an unmanned aero drone, an unmanned aeroplane, an RC car, a robotic toy, a vacuum cleaner such as a robotic vacuum cleaner, a robotic garden tool, a robotic construction utility, a robotic alert system, a robotic aging care unit, a robotic kid care unit, an electric drill, an electric mower, an electric vacuum cleaner, an electric metal working grinder, an electric heat gun, an electric press expansion tool, an electric saw or cutter, an electric sander and polisher, an electric shear and nibbler, an electric router, an electric tooth brush, an electric hair dryer, an electric hand dryer, a global positioning system (GPS) device, a laser rangefinder, a torch (flashlight), an electric street lighting, a standby power supply, uninterrupted power supplies, or another portable or stationary electronic device. In particular examples, the electrically-powered device is a vehicle.

Features described herein in relation to one aspect of the present disclosure are explicitly disclosed in combination with the other aspects, to the extent that they are compatible.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic diagram of a cross-section of a battery stack according to examples.

FIG. 2A is a schematic diagram of a cross-section of a battery stack according to examples, the cross-section taken along a first plane; FIG. 2B is a schematic diagram of a cross section of the battery stack depicted in FIG. 2A, the cross-section taken along a second plane orthogonal to the first plane.

FIG. 3 is a schematic diagram of a cross-section of a battery stack according to examples.

FIG. 4A is a schematic diagram of a first elevation of the battery stack depicted in FIG. 3; FIG. 4B is a schematic diagram of a second elevation of the battery stack depicted in FIG. 3, the second elevation orthogonal to the first elevation. The electrochemical cells of the battery stack have a contracted thickness.

FIG. 5A is a schematic diagram of a first elevation of the battery stack depicted in FIG. 3; FIG. 4B is a schematic diagram of a second elevation of the battery stack depicted in FIG. 3, the second elevation orthogonal to the first elevation. The electrochemical cells of the battery stack have an expanded thickness.

FIGS. 6, 7, and 8 are schematic cross-sections of portions of functionalised current collectors according to examples.

FIG. 9A is a schematic flow diagram of a method according to examples, depicting cross-sections of material at points in the method, the cross-sections taken along a first plane; FIG. 9B is a schematic flow diagram of the method depicted in FIG. 9A, the cross-sections taken along a second plane orthogonal to the first plane.

FIG. 10 is a schematic flow diagram of a method according to examples, depicting cross sections of material at points in the method.

FIG. 11 is a schematic diagram of an electrically-powered device according to examples.

### DETAILED DESCRIPTION

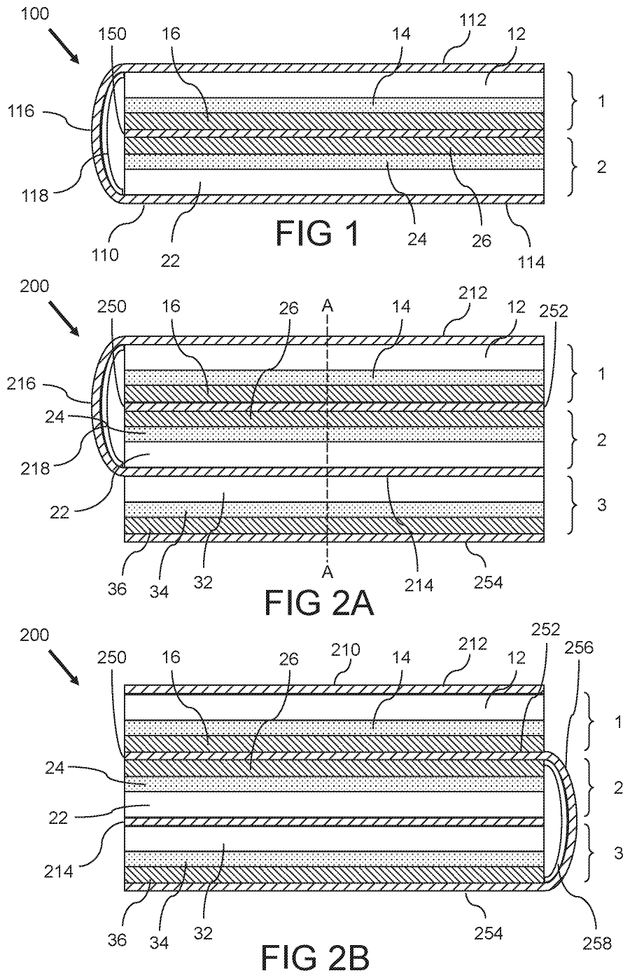

FIG. 1 is a schematic diagram of a cross-section of one example of a battery stack 100 comprising a plurality of electrochemical cells 1, 2. In this example, the plurality of electrochemical cells 1, 2 comprises a first cell 1 and a second cell. Each cell 1, 2 comprises a cathode layer 12, 22, an electrolyte layer 14, 24 abutting the cathode layer 12, 22, and an anode layer 16, 26 abutting the electrolyte layer 14, 24.

The battery stack 100 comprises a cathode current collector 110 comprising a first portion 112 and a second portion 114. The first portion 112 abuts the cathode layer 12 of the first cell 1. The second portion 114 abuts the cathode layer 22 of the second cell 2.

Between the first portion 112 and the second portion 114 of the cathode current collector 110, the cathode current collector 110 comprises an intermediate portion 116 having a surface facing the cells. The surface of the intermediate portion 116 facing the cells 1, 2 is coated with an electrically-insulating coating 118.

The battery stack 100 of FIG. 1 further comprises an anode current collector 150 which abuts the anode layer 16 of the first cell 1 and the anode layer 26 of the second cell; the anode layer 16 of the first cell 1 abuts a surface of the anode current collector 150, and the anode layer 26 of the second cell 2 abuts an opposing surface of the anode current collector 150.

The cells are arranged in a “back-to-back” fashion, such that a portion of the anode current collector 150 functioning as the anode current collector of the first cell 1 also functions as the anode current collector of the second cell 2, and so on. All of the battery stacks depicted in the Figures are arranged in this “back-to-back” fashion.

FIGS. 2A and 2B are schematic diagrams of cross-sections of another example of a battery stack 200. The cross-section shown in FIG. 2A is taken along a first plane, while the cross-section shown in FIG. 2B is taken along a second plane A-A orthogonal to the first plane.

The battery stack 200 depicted in FIGS. 2A and 2B comprises a plurality of cells 1, 2, 3 comprising a first cell 1, a second cell 2, and a third cell 3. The first cell 1 and second cell 2 correspond to the first cell 1 and second cell 2 depicted in FIG. 1.

The battery stack 200 comprises a cathode current collector 210 comprising a first portion 212 and a second portion 214. The first portion 212 abuts the cathode layer 12 of the first cell 1. The second portion 214 abuts the cathode layer 22 of the second cell 2. In this example, the second portion 214 of the cathode current collector 210 also abuts the cathode layer 32 of the third cell 3; the cathode layer 22 of the second cell 2 abuts a surface of the second portion 214 of the cathode current collector 210, and the cathode layer 32 of the third cell 3 abuts an opposing surface of the second portion 214 of the cathode current collector 210.

Between the first portion 212 and the second portion 214 of the cathode current collector 210, the cathode current collector 210 comprises an intermediate portion 216 having a surface facing the cells. The surface of the intermediate portion 216 facing the cells 1, 2, 3 is coated with an electrically-insulating coating 218.

The battery stack 200 further comprises an anode current collector 250 comprising a first portion 252 and a second portion 254. The first portion 252 abuts the anode layer 16 of the first cell. The second portion 256 abuts the anode layer 36 of the third cell 3.

Between the first portion 252 and the second portion 254 of the anode current collector 250, the anode current collector 250 comprises an intermediate portion 256 having a surface facing the cells. The surface of the intermediate portion 256 facing the cells 1, 2, 3 is coated with an electrically-insulating coating 258.

In this example, the first portion 252 of the anode current collector also abuts the anode layer 26 of the second cell 2, the anode layer 16 of the first cell 1 abuts a surface of the first portion 252 of the anode current collector 250, and the anode layer 26 of the second cell 2 abuts an opposing surface of the first portion 252 of the anode current collector 250.

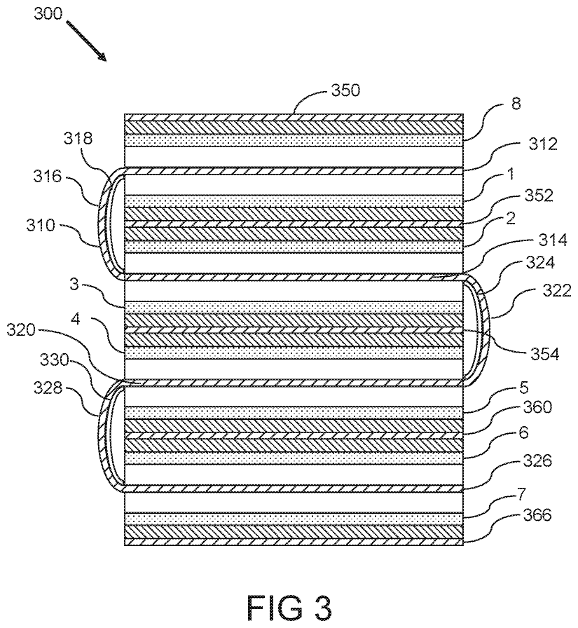

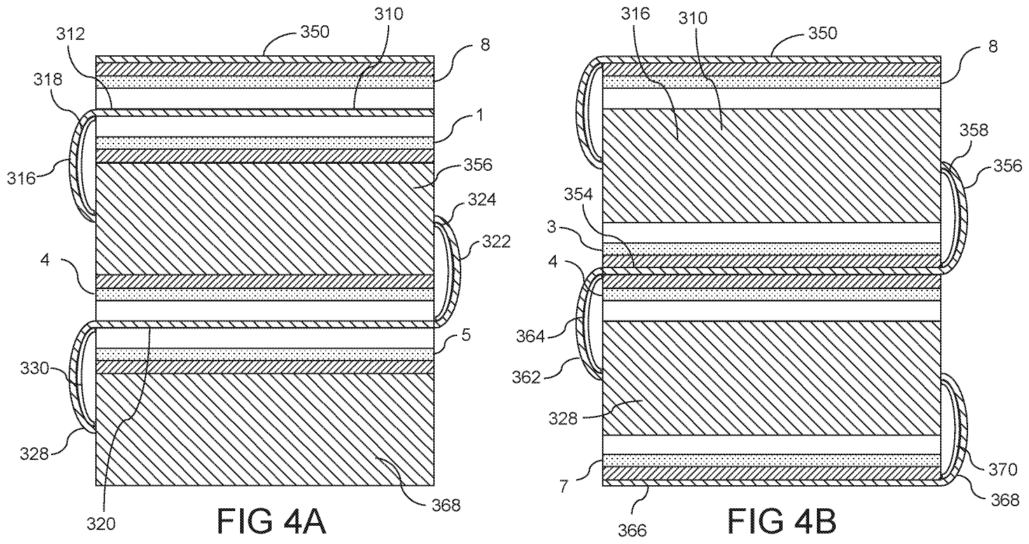

FIGS. 3 to 5B depict a battery stack 300 according to another example. In this example, the stack 300 is made of generally square layers and can be said to have a front, two sides and a back. FIG. 3 is a cross-section of the battery stack 300 taken through a first plane parallel to the front; FIG. 4A is a front elevation of the battery stack 300 viewed in the same direction as FIG. 3. FIG. 4B is a side elevation of the battery stack 300 viewed in a direction orthogonal to the view of FIG. 4A (e.g. the battery stack 300 is rotated 90 degrees anti-clockwise). In this example, the battery stack 300 comprises a plurality of cells 1, 2, 3, 4, 5, 6, 7, 8 comprising eight cells.

In each of the battery stacks depicted in FIGS. 3 to 5B, each cell comprises a cathode layer, an electrolyte layer, and an anode layer as shown in FIGS. 1, 2A, and 2B. For clarity, the reference numerals of the cathode layers, electrolyte layers, and anode layers are omitted from FIGS. 3 to 5B.

The battery stack 300 comprises a cathode current collector 310 comprising a first portion 312 which abuts the cathode layers of the first cell 1 and eighth cell 8, and a second portion 314 which abuts the cathode layers of the second cell 2 and the third cell 3. Between the first portion 312 and second portion 314, the cathode current collector 310 comprises a first intermediate portion 316 having a surface facing cells on a first side of the stack. The surface of the first intermediate portion 316 facing the cells 1, 2 is coated with an electrically-insulating coating 318.

The cathode current collector 310 further comprises a third portion 320 which abuts the cathode layers of the fourth cell 4 and the fifth cell 5. Between the second portion 314 and the third portion 320, the cathode current collector 310 comprises a second intermediate portion 322 having a surface facing cells on a second side of the stack. The surface of the second intermediate portion 322 facing the cells 3, 4 is coated with an electrically-insulating coating 324. The second intermediate portion 322 is arranged on a side of the battery stack 300 opposed to the first intermediate portion 316.

The cathode current collector 310 further comprises a fourth portion 326 which abuts the cathode layers of the sixth cell 6 and the seventh cell 7. Between the third portion 320 and the fourth portion 326, the cathode current collector 310 comprises a third intermediate portion 328 having a surface facing cells on the first side of the stack. The surface of the third intermediate portion 328 facing the cells 5, 6 is coated with an electrically-insulating coating 330. The third intermediate portion 330 is arranged on a side of the battery stack 300 opposed the second intermediate portion 322; the third intermediate portion 330 is arranged on the same side of the battery stack 300 as the first intermediate portion 310.

The battery stack 300 comprises an anode current collector 350 comprising a first portion 352 which abuts the anode layers of the first cell 1 and second cell 2, and a second portion 354 which abuts the anode layers of the third cell 3 and the fourth cell 4. Between the first portion 352 and second portion 354, the anode current collector 350 comprises a first intermediate portion 356 having a surface facing cells on the front of the stack. The surface of the first intermediate portion 356 facing the cells 2, 3 is coated with an electrically-insulating coating 358.

The anode current collector 350 further comprises a third portion 360 which abuts the anode layers of the fifth cell 5 and the sixth cell 6. Between the second portion 354 and the third portion 360, the anode current collector 350 comprises a second intermediate portion 362 having a surface facing cells on the back of the stack. The surface of the second intermediate portion 251 facing the cells 4, 5 is coated with an electrically-insulating coating 364. The second intermediate portion 362 is arranged opposed to the first intermediate portion 356.

The anode current collector 350 further comprises a fourth portion 366 which abuts the anode layer of the seventh cell 7. Between the third portion 360 and the fourth portion 366, the anode current collector 350 comprises a third intermediate portion 368 having a surface facing cells on the front of the stack. The surface of the third intermediate portion 368 facing the cells 6, 7 is coated with an electrically-insulating coating 370. The third intermediate portion 368 is arranged opposed the second intermediate portion 364; the third intermediate portion 368 is arranged on the front of the battery stack 300 relatively below first intermediate portion 356.

Battery stacks comprising further cells are envisaged, the cells being electrically connected in the same fashion demonstrated in the Figures, where intermediate portions of current collector coated with electrically-insulating coating are arranged alternately across the battery stack.

The cells of the battery stack 300 expand and contract across charge and discharge cycles (e.g. at least one, or each of the cathode, electrolyte, and anode layers of each of the cells expands and contracts across charge and discharge cycles). The battery stack 300 is depicted in FIGS. 3, 4A and 4B as comprising cells having a contracted thickness. In these examples, the intermediate portions 316, 322, 330, 256, 362, 368 of the cathode current collector 310 and anode current collector 350 are spaced apart from the cells of the battery stack 300 (i.e. the electrically-insulating coating of the intermediate portions does not abut the cells of the battery stack 300 along a substantial portion of the surface of the intermediate portions).

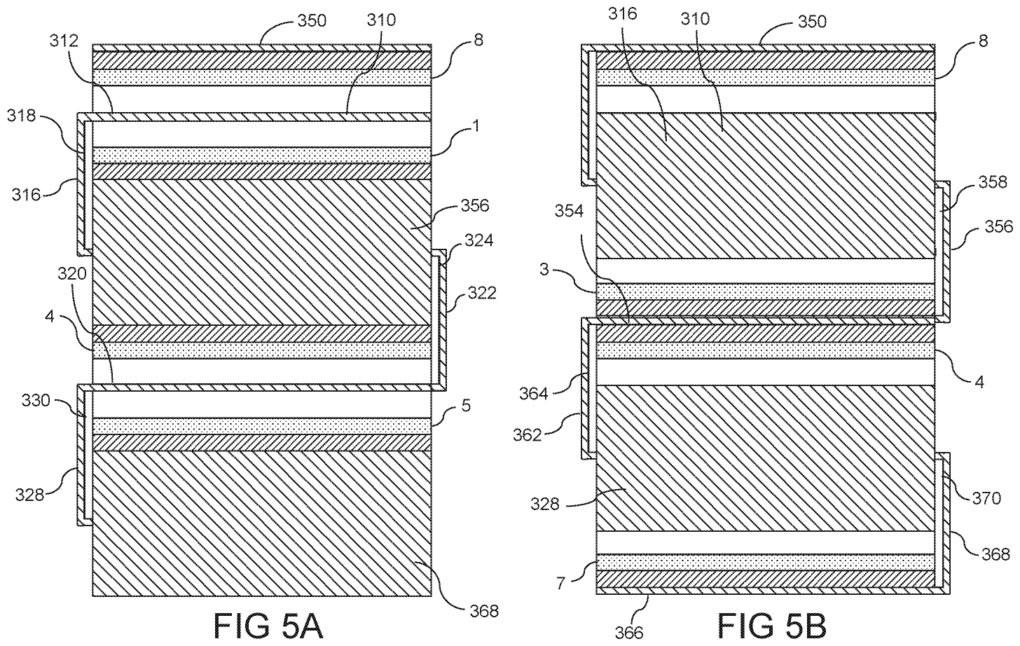

The battery stack 300 is depicted in FIGS. 5A and 5B as comprising cells having an expanded thickness. In these examples, the electrically-insulating-coated intermediate portions 316, 322, 330, 256, 362, 368 of the cathode current collector 310 and anode current collector 350 abut the cells of the battery stack 300.

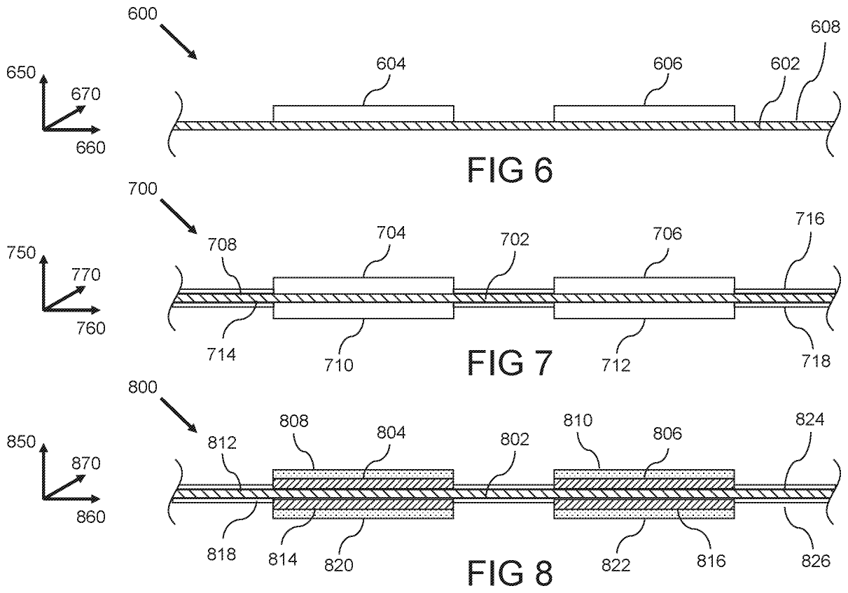

FIGS. 6, 7, and 8 depict portions of functionalised current collectors according to examples. The functionalised current collector 600 of FIG. 6 comprises a current collector layer 602, and a plurality of electrodes 604, 606, each abutting respective portions of the first surface 608 of the current collector layer 602.

The functionalised current collector 600 has a thickness along a first dimension 650, a length along a second dimension 660, and a width along a third dimension 670. In this example, the functionalised current collector 600 has its greatest extent along its length in the second dimension 660, and its smallest extent along its thickness in the first dimension 650.

The functionalised cathode current collector 700 of FIG. 7 comprises a cathode current collector layer 702, and a plurality of cathodes 704, 706, each abutting respective portions of the first surface 708 of the cathode current collector layer 702.

The cathode current collector 700 comprises a further plurality of cathodes 710, 712, each abutting respective portions of the second surface 714 of the cathode current collector layer 702. In this example, each of the cathodes 704, 706 on the first surface 708 is arranged opposed to corresponding cathodes 710, 712 on the second surface 714 of the cathode current collector layer 702.

Between each of the cathodes 704, 706 arranged on the first surface 708 of the cathode current collector layer 702, the first surface 708 is coated with an electrically-insulating coating 718. Similarly, between each of the cathodes 710, 712 on the second surface 716 of the cathode current collector layer 702, the second surface 716 is coated with an electrically-insulating coating 718. In other examples (not shown), electrically-insulating coating is provided on only one of the surfaces 708, 716 of the cathode current collector layer 702. In examples, the electrically-insulated portions of cathode current collector layer 702 correspond to the intermediate portions of cathode current collector depicted in the battery stacks of FIGS. 1 to 5B.

In examples (not shown), each cathode 704, 706, 710, 712 abuts respective electrolyte layers. Each of the electrolyte layers has a length and width substantially the same as its corresponding cathode layer, such that the electrolyte layer coats a surface of the cathode layer opposed to the cathode current collector layer 702.

The functionalised cathode current collector 700 has a thickness along a first dimension 750, a length along a second dimension 760, and a width along a third dimension 770. In this example, the functionalised current collector 700 (or at least the cathode current collector layer 702) has its greatest extent along its length in the second dimension 760, and its smallest extent along its thickness in the first dimension 750.

The functionalised anode current collector 800 of FIG. 8 comprises an anode current collector layer 802, a plurality of anodes 804, 806, each abutting respective portions of the first surface 808 of the anode current collector layer 802, and a plurality of electrolyte layers 810, 812, each abutting respective anodes 804, 806. The anode current collector 800 comprises a further plurality of anodes 814, 816, each abutting respective portions of the second surface 818 of the anode current collector layer 802, and a further plurality of electrolyte layers 820, 822, each abutting respective anodes 814, 816 of the further plurality of anodes. In this example, each of the anodes 804, 806, 814, 816 on the first surface 808 is arranged opposed to corresponding anodes 814, 816 on the second surface 818 of the anode current collector layer 802.

Between each of the anodes 804, 806 arranged on the first surface 808 of the anode current collector layer 802, the first surface 808 is coated with an electrically-insulating coating 824. Similarly, between each of the anodes 814, 816 on the second surface 818 of the anode current collector layer 802, the second surface 818 is coated with an electrically-insulating coating 826. In other examples (not shown), electrically-insulating coating is provided on only one of the surfaces 808, 818 of the anode current collector layer 802. In examples, the electrically-insulated portions of anode current collector layer 702 correspond to the intermediate portions of anode current collector depicted in the battery stacks of FIGS. 1 to 5B.

In the example of FIG. 8, each electrolyte layer 810, 812, 820, 822 has a length and width substantially the same as its corresponding anode, such that the electrolyte layer coats a surface of the anode layer opposed to the anode current collector layer 802.

The functionalised anode current collector 800 has a thickness along a first dimension 850, a length along a second dimension 860, and a width along a third dimension 870.

In this example, the functionalised anode collector 800 (or at least the anode current collector layer 802) has its greatest extent along its length in the second dimension 860, and its smallest extent along its thickness in the first dimension 850.

In examples the functionalised current collectors 600, 700, 800 of FIGS. 6, 7, and 8 comprise further electrodes along the surface(s) of the current collector layer (not shown).

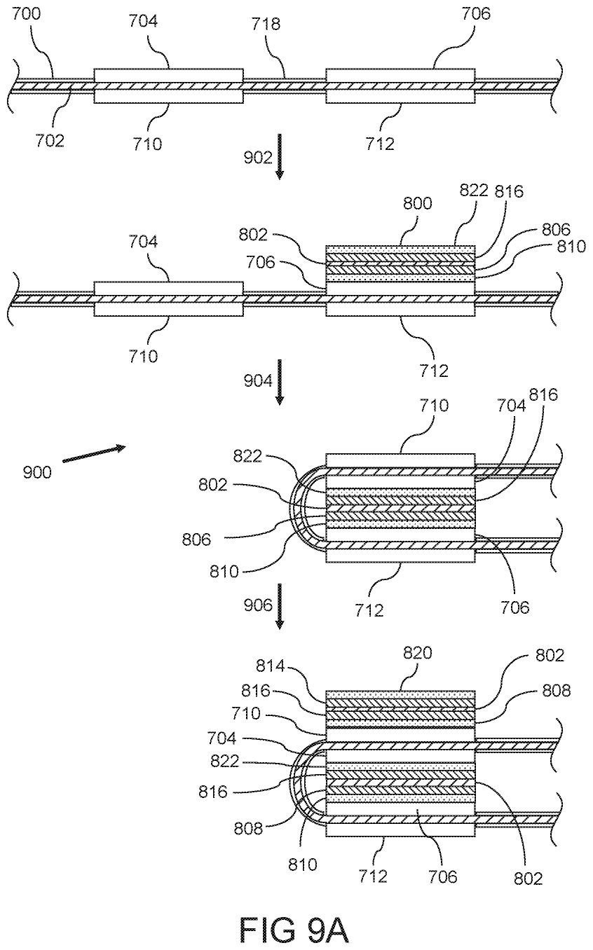

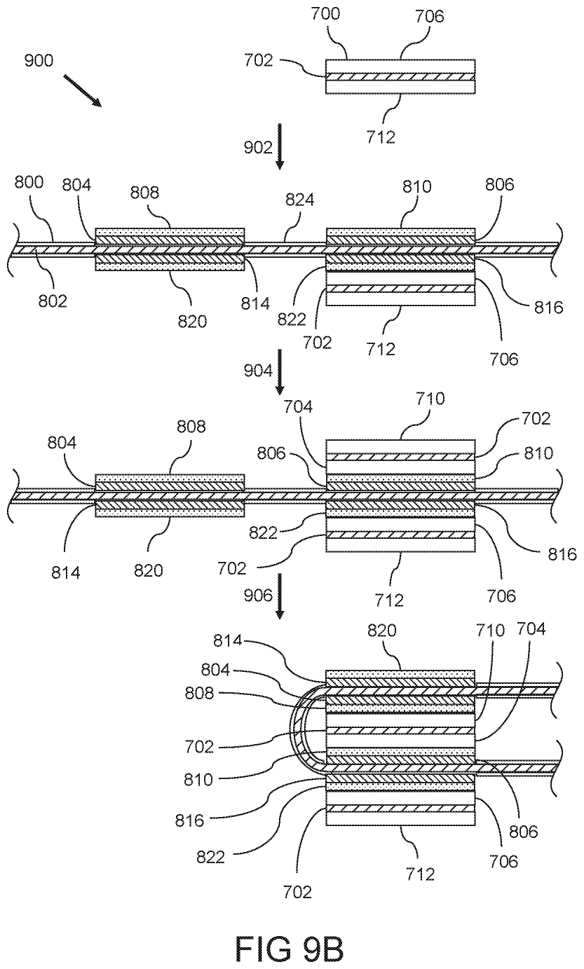

FIG. 9A is a schematic flow diagram of an example of a method 900 of manufacturing a battery stack, depicting cross-sections of material at points in the method, the cross-sections taken along a first plane; the schematic flow diagram of FIG. 9B depicts the same method 900, the cross-sections taken along a second plane orthogonal to the first plane.

The method 900 employs a functionalised current collector 700 as depicted in FIG. 7, and a functionalised anode current collector 800 as depicted in FIG. 8. The cross-sections depicted in FIG. 9A are taken along the same plane as depicted in FIG. 7, e.g. the plane which extends along the thickness and length of the cathode current collector 800. Throughout the method 900, the functionalised anode current collector 800 is arranged orthogonal to the functionalised cathode current collector 700 (e.g. in its substantially flat form, the functionalised anode current collector 800 extends along its length in a direction orthogonal to the length along which the functionalised cathode current collector extends 700). Therefore, the cross-sections depicted in FIG. 9B are taken along the same plane as depicted in FIG. 8, e.g. the plane which extends along the thickness and length of the anode current collector 800. Put another way, in the method 900 as depicted, the first dimension 750 of the functionalised cathode current collector 700 (along which the functionalised cathode current collector 700 has a thickness) corresponds to the first dimension 850 of the functionalised anode current collector 800 (along which the functionalised anode current collector 800 has a thickness); the second dimension 760 of the functionalised cathode current collector 700 (along which the functionalised cathode current collector 700 has a length) corresponds to the third dimension 870 of the functionalised anode current collector 800 (along which the functionalised anode current collector 800 has a width); and the third dimension 770 of the functionalised cathode current collector 700 (along which the functionalised cathode current collector 700 has a width) corresponds to the second dimension 860 of the functionalised anode current collector 800 (along which the functionalised anode current collector 800 has a length).

In this example, the method 900 of manufacturing the battery stack comprises providing the functionalised current collector 700. The method 900 further comprises providing 902 the functionalised anode current collector 800 such that the electrolyte layer 810 of the functionalised anode current collector 800 abuts the cathode 706 of the functionalised cathode current collector 700.

The method 900 further comprises folding 904 the functionalised cathode current collector 700 along its width, along a portion between cathodes 704, 706 wherein the first surface 708 of the cathode current collector 702 is coated with an electrically-insulating coating 716, such that a further cathode 704 of the functionalised cathode current collector 700 abuts the second electrolyte layer 822 of the functionalised anode current collector 800. In particular, the surface of the further cathode 704 (opposed to the portion of cathode current collector layer 702 which the cathode 704 abuts) is in contact with substantially all of the surface of the further electrolyte layer 822 (opposed to the portion of anode current collector layer 802 which the underlying anode 816 abuts). The functionalised cathode current collector 700 is folded such that the electrically-insulating coating 716 on the first surface 708 of the cathode current collector 702 faces the cathode 704 and the electrolyte layer 822 which have been brought into contact through the folding. The functionalised cathode current collector 700 is folded such that a cathode 710 is exposed at the uppermost point of the stack of cells. Where the electrodes of the functionalised current collectors 700, 800 have a contracted thickness (or do not have an expanded thickness), the functionalised cathode current collector 700 is folded such that the electrically-insulating coating 716 on the first surface 708 of the cathode current collector 702 is spaced apart from the cathode 704 and the electrolyte layer 822 which have been brought into contact through the folding.

The method 900 further comprises folding 906 the functionalised anode current collector 800 along its width, along a portion between anodes 704, 806 wherein the first surface 812 of anode current collector 802 is coated with an electrically-insulating coating 824, such that a yet further electrolyte layer 808 of the functionalised anode current collector 800 abuts a cathode 710 of the functionalised cathode current collector 700 which is uppermost in the battery stack being formed. In particular, the surface of the electrolyte layer 808 of the functionalised anode current collector 800 (the surface opposed to the portion of anode current collector layer 802 which the underlying anode 804 abuts) is in contact with substantially all of the surface of the cathode 710 (the surface opposed to the portion of cathode current collector layer 702 which the cathode 710 abuts). The functionalised anode current collector 800 is folded such that the electrically-insulating coating 824 on the first surface 812 of the anode current collector 802 faces the cathode 710 and the electrolyte layer 808 which have been brought into contact through the folding. The functionalised anode current collector 800 is folded such that an electrolyte layer 820 is exposed at the uppermost point of the stack of cells. Where the electrodes of the functionalised current collectors 700, 800 have a contracted thickness (or do not have an expanded thickness), the functionalised anode current collector 800 is folded such that the electrically-insulating coating 824 on the first surface 812 of the anode current collector 802 is spaced apart from the cathode 710 and the electrolyte layer 808 which have been brought into contact through the folding.

The functionalised anode current collector and functionalised cathode current collector have suitable flexibility and/or ductility along the portions of material between cathodes or anodes (as applicable) to enable folding of the functionalised anode current collector or functionalised cathode current collector during the method.

Further cells can be provided in the battery stack by further alternate folding of the current collectors towards the battery stack as depicted in FIGS. 9A and 9B.

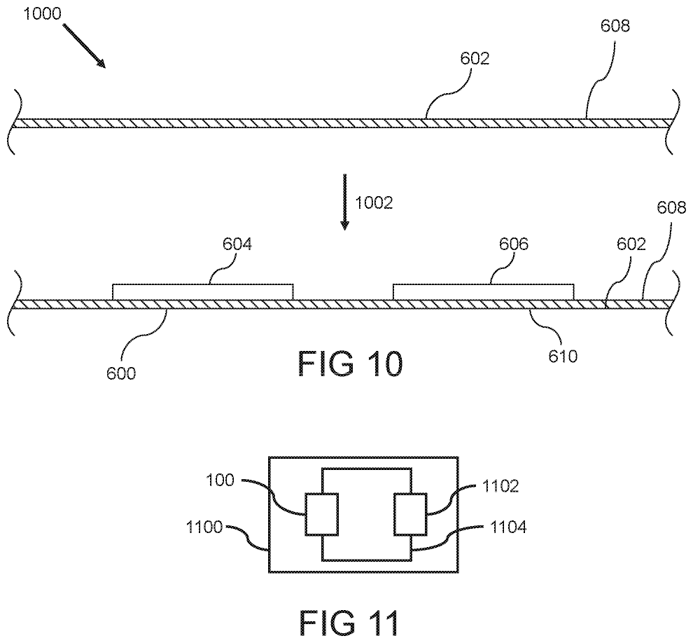

FIG. 10 is a schematic flow diagram of a method according to an example, depicting cross sections of material at points in the method of manufacturing the functionalised current collector 600. The method comprises providing a current collector layer 602 having a first surface 608, and providing 1002 a plurality of electrodes 604, 606 on the first surface 608 of the current collector layer 602. Each of the electrodes 604, 606 is spaced apart from the other electrodes 606, 604 of the plurality of electrodes. In this example, providing 1002 the plurality of electrodes comprises screen printing electrode material onto the first surface 608 of the current collector layer 602, and sintering electrode material to provide sintered electrodes 604, 606. Electrode material corresponding to each of the electrodes of the plurality of electrodes is deposited on the first surface 608 before performing the sintering, such that a single sintering step is carried out to provide all of the sintered electrodes 604, 606 in the plurality of electrodes in a single sintering step. In the example depicted, a mask is employed in the screen printing (not shown), such that only the electrode material which corresponds to the sintered electrodes 604, 606 is provided to the first surface. In other examples (not shown), the first surface 608 of the current collector layer 602 is substantially entirely coated with electrode material, and then portions of electrode material removed to provide discrete portions of electrode material. Typically, the electrode material substantially entirely covering the first surface 608 is sintered, and then portions of the sintered electrode are removed (e.g. ablated) to provide discrete electrodes 604, 606.

FIG. 10 depicts functionalising only one surface of the current collector. In examples (not shown), the second surface 610 is functionalised by applying the method described above on the second surface 610.

In examples (not shown), the method comprises providing electrically-insulating coating to one or more intermediate portions of the first 608 and/or second 610 surface of the current collector 602 between the electrodes 604, 606 arranged on the first and/or second surface.

FIG. 11 is a schematic diagram of an electrically-powered device according to examples. The electrically-powered device 1100 comprises the battery stack 100 depicted in FIG. 1. In other examples (not shown) the battery stack is the battery stack 200 depicted in FIGS. 2A and 2B, or the battery stack 300 depicted in FIGS. 3 to 5B.

The electrically-powered device comprises an element 1102 which converts electric power from the battery stack 100 to another form of energy (e.g. mechanical work, heat, light, and so on). The battery stack 100 and element 1102 are connected by one or more electrical conduits 1104 which, in examples, forms an electrical circuit.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A battery stack comprising a plurality of electrochemical cells, each electrochemical cell of the plurality of electrochemical cells comprising:
a cathode layer;
an electrolyte layer arranged on the cathode layer; and
an anode layer arranged on the electrolyte layer;
the battery stack comprising:
a cathode current collector comprising at least a first portion and a second portion,
the first portion arranged on the cathode layer of a first electrochemical cell of the plurality of electrochemical cells,
the second portion arranged on the cathode layer of a second electrochemical cell of the plurality of electrochemical cells;
wherein, between the first portion and second portion of the cathode current collector, the cathode current collector comprises an intermediate portion, at least one surface of the intermediate portion coated with an electrically-insulating coating.

2. The battery stack according to claim 1 comprising an anode current collector, the anode current collector comprising at least a first portion and a second portion,
the first portion arranged on the anode layer of the first electrochemical cell,
the second portion arranged on the anode layer of a third electrochemical cell of the plurality of electrochemical cells;
wherein, between the first portion and second portion of the anode current collector, the anode current collector comprises an intermediate portion, at least one surface of the intermediate portion coated with an electrically-insulating coating.

3. The battery stack according to claim 2, wherein a first surface of the first portion of the anode current collector abuts the anode layer of the first electrochemical cell, and a second surface of the first portion of the anode current collector, opposed to the first surface, abuts the anode layer of the second electrochemical cell.

4. The battery stack according to claim 2, wherein a first surface of the second portion of the cathode current collector abuts the cathode layer of the second electrochemical cell, and a second surface of the second portion of the cathode current collector, opposed to the first surface, abuts the cathode layer of the third electrochemical cell.

5. The battery stack according to claim 1, wherein each electrochemical cell of the plurality of cells has a thickness which, in use, varies between an expanded thickness and a contracted thickness, the expanded thickness greater than the contracted thickness; and wherein
when the thickness of each electrochemical cell is the expanded thickness, the electrically-insulating coating of the intermediate portion of the cathode current collector abuts a side of at least one of the electrochemical cells; and/or
when the thickness of each electrochemical cell is the contracted thickness, the electrically-insulating coating of the intermediate portion of the cathode current collector is spaced apart from a side of at least one of the electrochemical cells.

6. The battery stack according to claim 1, wherein the plurality of electrochemical cells is a plurality of secondary electrochemical cells.

7. The battery stack according to claim 1, wherein the plurality of electrochemical cells is a plurality of solid-state electrochemical cells.

8. The battery stack according to claim 1, provided in a pouch cell.

9. A method of manufacturing a battery stack comprising a plurality of electrochemical cells, the method comprising:
providing a cathode current collector;
providing a first cathode arranged on a surface of a first portion of the cathode current collector;
providing a first electrolyte arranged on the first cathode;
providing a first anode arranged on the first electrolyte;
providing an anode current collector such that the first anode is arranged on a first surface of a first portion of the anode current collector;
providing a second anode arranged on a second surface of the first portion of the anode current collector, the second surface opposed to the first surface;
providing a second electrolyte arranged on the second anode;
providing a second cathode arranged on a first surface of a second portion of the cathode current collector;
folding the cathode current collector such that the second cathode is arranged on the second electrolyte;
wherein, between the first portion and second portion of the cathode current collector, the cathode current collector comprises an intermediate portion, at least one surface of the intermediate portion coated with an electrically-insulating coating.

10. The method according to claim 9, further comprising:
providing a third cathode arranged on a second surface of the second portion of the cathode current collector, the second surface opposed to the first surface;
providing a third electrolyte arranged on the third cathode;
providing a third anode on a first surface of a second portion of the anode current collector; and
folding the anode current collector such that the third anode is arranged on the third electrolyte;
wherein, between the first portion and second portion of the anode current collector, the anode current collector comprises an intermediate portion, at least one surface of the intermediate portion coated with an electrically-insulating coating.

11. The method according to claim 10, wherein the anode current collector extends along a length, and the folding the anode current collector comprises folding the anode current collector substantially perpendicular to its length.

12. The method according to claim 9, wherein the cathode current collector extends along a length, and the folding the cathode current collector comprises folding the cathode current collector substantially perpendicular to its length.

13. The method according to claim 9, wherein the providing the first anode layer and the first electrolyte layer is performed simultaneously.

14. The method according to claim 9, wherein the providing the anode current collector such that the first anode is arranged on a first surface of a first portion of the anode current collector, and the providing the second anode arranged on the second surface of the first portion of the anode current collector, are performed simultaneously.

15. A functionalised current collector comprising:
a current collector layer; and
a plurality of electrodes, each of the electrodes abutting respective portions of a first surface of the current collector layer;
wherein each of the electrodes is spaced apart from the other electrodes of the plurality of electrodes.

16. The functionalised current collector according to claim 15 comprising a further plurality of electrodes, each of the electrodes abutting respective portions of a second surface of the current collector layer, the second surface opposed to the first surface.

17. The functionalised current collector according to claim 16, wherein each of the electrodes of the plurality of electrodes on the first surface of the current collector is arranged opposed to a corresponding electrodes of the further plurality of electrodes on the second surface of the current collector.

18. The functionalised current collector according to claim 15 comprising an electrically-insulating coating between each of the electrodes of the plurality of electrodes on the first surface.

19. The functionalised current collector according to claim 15, wherein the plurality of electrodes is a plurality of anodes or is a plurality of cathodes.

20. The functionalised current collector according to claim 15, wherein each of the electrodes of the plurality of electrodes comprises an electrolyte layer on a surface of the electrode opposed to the current collector layer.

21. A method of manufacturing a functionalised current collector, the method comprising:
providing a current collector layer; and
providing a plurality of electrodes on a first surface of the current collector layer, each of the electrodes spaced apart from the other electrodes of the plurality of electrodes.

22. An electrically-powered device comprising a battery stack according to any of claim 1.
